(19) United States
(12) Patent Application Publication
(10) Pub. No.: US 2011/0309914 A1
(43) Pub. Date: Dec. 22, 2011

(54) REMOTE CONTROL SYSTEM

(75) Inventor: LUNG DAI, Tu-Cheng (TW)

(73) Assignee: HON HAI PRECISION INDUSTRY CO., LTD., Tu-Cheng (TW)

(21) Appl. No.: 12/858,445

(22) Filed: Aug. 18, 2010

(30) Foreign Application Priority Data
Jun. 22, 2010 (TW) 99120176

(51) Int. Cl. G05B 19/02

(52) U.S. Cl. 340/12.22

(57) ABSTRACT

A remote control system includes an emitter and a remote controller. The emitter is installed in an electronic device and is configured for emitting a search signal. The remote controller includes a wireless receiving module and a beacon module. The wireless receiving module is configured for receiving the search signal transmitted from the emitter to activate the beacon module to emit a guiding signal.

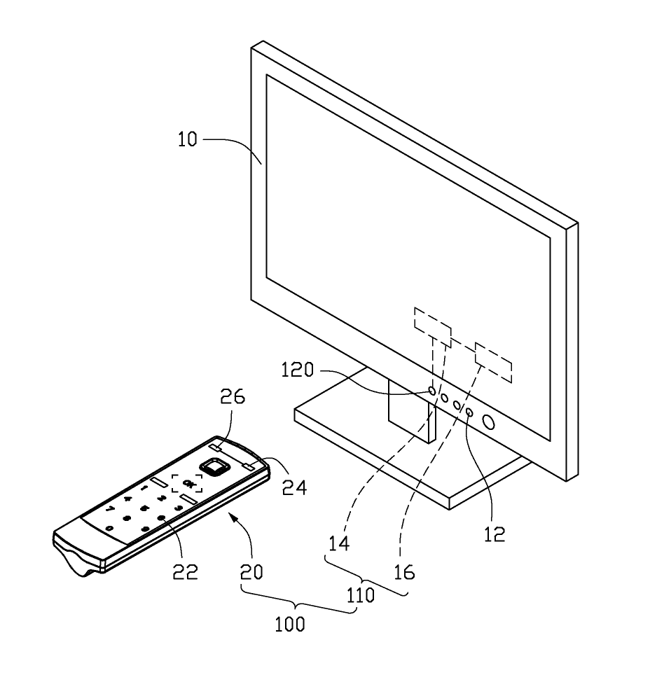

### BACKGROUND

1. Technical Field

The present disclosure relates to a remote control system.

2. Description of Related Art

With so many electronic devices controlled by remote controllers, it is common for users to misplace remote controllers, it would take lots of times to find out the remote controller. This is inconvenient.

Therefore, it is desirable to provide a remote control system and a method for locating a misplaced remote controller.

### BRIEF DESCRIPTION OF THE DRAWING

Many aspects of the present disclosure can be better understood with reference to the accompanying drawings. The components in the drawings are not necessarily drawn to scale, the emphasis instead being placed upon clearly illustrating the principles of the present disclosure. Moreover, in the drawings, like reference numerals designate corresponding parts throughout the several views, and all the views are schematic.

The drawing is an isometric and schematic view of a remote control system according to an exemplary embodiment.

### DETAILED DESCRIPTION

Embodiments of the present disclosure will now be described in detail below and with reference to the drawings.

Referring to the drawing, a remote control system 100, according to an exemplary embodiment, is applied with an electronic device 10. The remote control system 100 includes a remote controller 20 for emitting control signals to the electronic device 10 and an emitter 110 installed in the electronic device 10 for emitting a search signal for locating the remote controller 20. The remote controller 20 includes a beacon module 26 for responding to the search signal to emit a guiding signal.

The electronic device 10 is a television (TV). However, in alternative embodiments, the electronic device can be a projector, a DVD drive, or a multimedia player for example. The TV 10 includes a number of first buttons 12. One of the first buttons 12 is a locator button 120.

The emitter 110 includes a timing module 14 and a search signal emitting module 16. The locator button 120 is electrically coupled to the timing module 14. The timing module 14 is also electrically coupled to the search signal emitting module 16 and is configured for timing the duration of pressing of the locator button 120. In the present embodiment, when the button 120 is pressed longer than a predetermined time, such as 2 seconds, the timing module 14 will activate the search signal emitting module 16 to emit a signal for locating the remote controller 20. The search emitting module 16 may be a BLUETOOTH emitter for wireless transmission of the search signal.

It should be noted that the locator button 120 may also be operable to activate other functions such as muting audio output of the TV 10 when pressed. The mute function can be activated immediately when the locator button 120 is pressed rather than waiting the predetermined time and be deactivated when the locator button 120 is pressed again.

The remote controller 20 includes a number of second buttons 22, a wireless receiving button 24, and the beacon module 26. In this present embodiment, the beacon module 26 is a speaker. The wireless receiving module 24 is a BLUETOOTH receiver configured for receiving the search signal transmitted from the search signal emitting module 16. When the receiving module 24 receives the search signal it activates the speaker 26 to emit sound. As a result, a user can easily locate the misplaced remote controller 20.

In use, when the locator button 120 is pressed, the TV 10 is muted, it the button is kept pressed for longer than the predetermined time, then the search signal emitting module 16 is controlled to emit the search signal. At the same time, the timing module 14 activates the search signal emitting module 16 to emit the search signal to the wireless signal receiving module 24 of the remote controller 20 to activate the beacon module 26 to emit sound.

It will be understood that the above particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A remote control system comprising:
an emitter installed in an electronic device and configured for emit a search signal; and
a remote controller comprising a wireless receiving module and a beacon module, the wireless receiving module configured for receiving the search signal transmitted from the emitter to activate the beacon module to emit a guiding signal.

2. The remote control system of claim 1, wherein the wireless receiving module is a BLUETOOTH receiver.

3. The remote control system of claim 1, wherein the beacon module is a speaker.

4. A remote control system comprising:
an emitter installed in an electronic device, the emitter comprising a timing module which is coupled to a locator button of the electronic device, and a search signal emitting module, the timing module configured for timing the duration of pressing of the locator button and activating the search signal emitting module to emit a search signal upon a condition that the locator button is pressed longer than a predetermined time; and
a remote controller comprising a wireless receiving module and a beacon module, the wireless receiving module configured for receiving the search signal transmitted from the search signal emitting module to activate the beacon module to emit a guiding signal.

5. The remote control system of claim 4, wherein the search signal emitting module is a BLUETOOTH emitter, the wireless receiving module is a BLUETOOTH receiver.

6. The remote control system of claim 4, wherein the beacon module is a speaker.

7. The remote control system of claim 4, wherein the locator button is a mute button of the electronic device, when the locator button is pressed, the electronic device works in a mute mode.

8. The remote control system of claim 4, wherein the predetermined time is 2 seconds.
